(19) United States
(12) Patent Application Publication
(10) Pub. No.: US 2020/0285472 A1
(43) Pub. Date: Sep. 10, 2020

(54) Context-Switching Method and Apparatus

(71) Applicants: Goke Taiwan Research Laboratory Ltd., Taipei City (TW); Xinsheng Intelligent Technology Co., Ltd., JIANGSU (CN)

(72) Inventors: Po-Chien Chang, Taipei City (TW); Chih-Hao Tseng, Hsinchu County (TW)

(21) Appl. No.: 16/291,059

(22) Filed: Mar. 4, 2019

(51) Int. Cl. G06F 9/30; G06F 9/46; G06F 9/48

(52) U.S. Cl. CPC G06F 9/30123; G06F 9/4837; G06F 9/485; G06F 9/462

(57) ABSTRACT

A semiconductor apparatus for reducing context-switch time includes at least one CPU, at least one memory and a logic circuit. The central processor unit includes a control unit, a process unit and registers. The memory includes at least one region for storing information of multiple tasks. The information of each of the tasks includes an identification, priority, status and context. The logic circuit uses direct memory access to read and write the registers of the CPU and move data between the CPU registers and the memory. The logic circuit is operable to instruct the control unit to stop and resume the execution of CPU instruction.

### BACKGROUND OF INVENTION

### 1. Field of Invention

The present invention relates to switches of contexts and, more particularly, to a method and apparatus for reducing context-switch time.

### 2. Related Prior Art

A central processing unit (‘CPU’) is an electronic circuit used in a computer to carry out the instructions of a computer program by performing the basic arithmetic, logic, controlling and input/output (I/O) operations specified by the instructions. An early-day computer includes a single CPU. To execute multiple programs or tasks, a program or task is completed before a following program or task is executed. However, this process keeps a user of the computer waiting all the time.

To solve the foregoing problem, a program or task can be cut into fragments. The single CPU executes a fragment of a program or task and then executes a fragment of another program or task. This process makes the user feel that the CPU executes multiple programs or tasks synchronously and is hence referred to as ‘multi-task.’

Referring to FIG. 1, time-division multiplexing is a method for executing programs or tasks in a multi-task manner. CPU time is cut into multiple segments. For example, the CPU executes ‘Task 1’ in the first segment of the CPU time. The CPU records the status of ‘Task 1’ (‘snapshot’) and gets a snapshot of ‘Task 2’ when the first segment is about to expire. The CPU executes ‘Task 2’ in the second segment of the CPU time. The CPU records another snapshot of ‘Task 2’ and gets a snapshot of ‘Task 3’ when the second segment is about to expire. The CPU executes ‘Task 3’ in the third segment of the CPU time. The CPU records another snapshot of ‘Task 3’ and gets a snapshot of ‘Task 4’ when the third segment of the CPU time is about to expire. The CPU executes ‘Task 4’ in the fourth segment of the CPU time. The CPU records another snapshot of ‘Task 4’ and gets the snapshot of ‘Task 1’ when the fourth segment of the CPU time is about to expire. The foregoing repeats.

Context switch is used to record and get snapshots in the time-division multiplexing. According to the context switch, contexts of registers of the CPU related to a task currently executed in the CPU are recorded in a region of a memory, and a snapshot of a next task to be executed in the CPU is transferred to other registers of the CPU from another region of the memory, thereby recording and getting snapshots. Conventionally, software is used to move the contexts of the registers of CPU to the memory, one after another, and then transfer the snapshot of the next task to the corresponding registers of the CPU. In many applications, the need for executing the tasks in a multi-task manner at high speed must be taken into consideration during the design of a product. It takes hundreds or even thousands of instruction cycles of the CPU to complete the recording of a snapshot and the transferring of another snapshot. Therefore, it always causes some impacts on the task execution performance.

Referring to FIG. 2, in same CPU time, less time could be spent on actually executing the tasks if more time is spent on the context switch. That is, the performance of the multiplexing gets lower as more time is spent on the context switch.

It is difficult to improve the performance of the multiplexing because the context switch is executed by the software and it takes hundreds or even thousands of instruction cycles of the CPU to complete the context switch in most multiplexing environments.

The present invention is therefore intended to obviate or at least alleviate the problems encountered in prior art.

### SUMMARY OF INVENTION

It is an objective of the present invention to provide an efficient semiconductor apparatus for reducing context-switch time.

It is another objective of the present invention to provide a reliable apparatus for reducing context-switch time.

To achieve the foregoing objectives, the semiconductor apparatus for reducing context-switch time includes at least one CPU, at least one memory and a logic circuit. The CPU includes a control unit, a process unit and registers. The memory includes at least one region for storing information of multiple tasks. The information of each of the tasks includes an identification, priority, status and context. The logic circuit uses direct memory access to read and write the registers of the CPU and move data between the registers of the CPU and the memory. The logic circuit is operable to instruct the control unit to stop and resume execution of the CPU.

Other objectives, advantages and features of the present invention will be apparent from the following description referring to the attached drawings.

### BRIEF DESCRIPTION OF DRAWINGS

The present invention will be described via detailed illustration of the preferred embodiment versus the prior art referring to the drawings wherein:

FIG. 1 shows a conventional time-division multiplexing method along a timeline;

FIG. 2 shows execution of tasks and switching of contexts along a timeline;

FIG. 3 is a block diagram of a context-switching apparatus according to the preferred embodiment of the present invention;

FIG. 4 is flow chart of a context-switching method executed in the context-switching apparatus shown in FIG. 3; and

FIG. 5 is block diagram of the context-switching apparatus of FIG. 3 in operation.

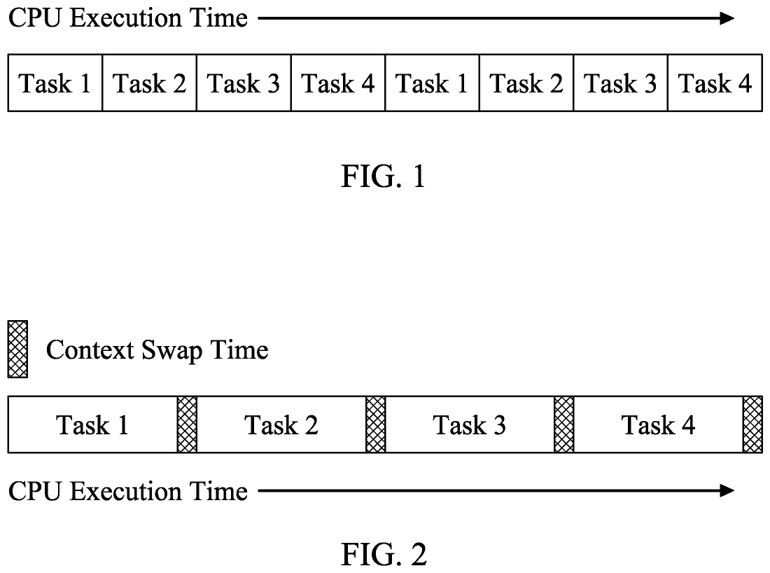

### DETAILED DESCRIPTION OF PREFERRED EMBODIMENT

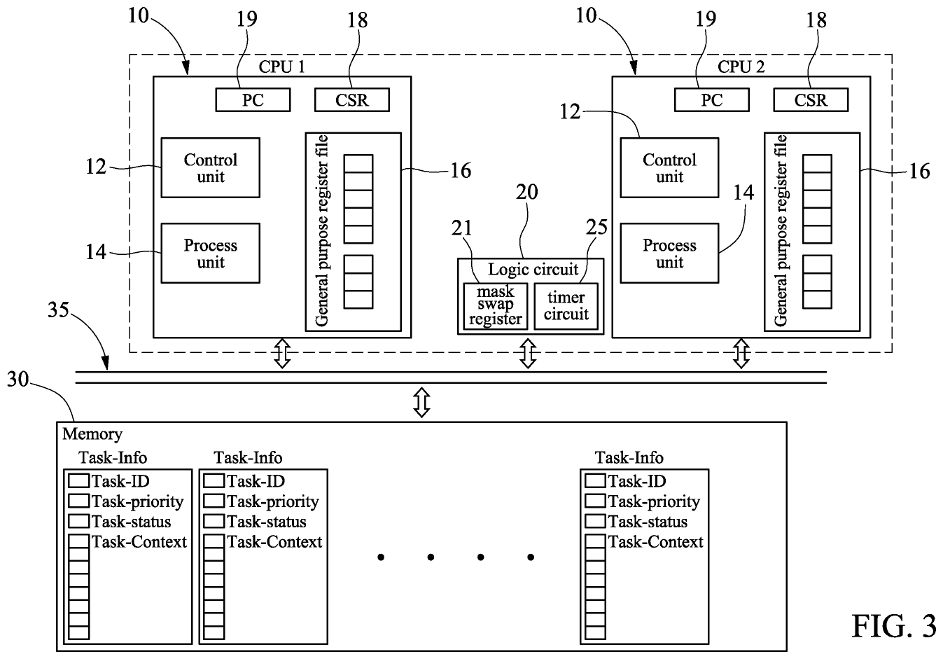

Referring to FIG. 3, a semiconductor apparatus for reducing context-switch time includes at least one CPU 10, a logic circuit (or ‘context-changer’) 20 and at least one memory 30 according to the preferred embodiment of the present invention. Preferably, the semiconductor apparatus includes two CPU 10. The logic circuit 20 uses direct memory access to read and write each CPU 10 and move data between each CPU 10 and the memory 30.

Each CPU 10 includes a control unit 12, a process unit 14 and multiple registers. The registers include at least one general purpose register file 16, at least one control and status register (‘CSR’) 18 and at least one program counter register (‘PC’) 19. The control unit 12 is used to control the other elements of the CPU 10 and receive and send commands. The process unit 14 executes the CPU instruction dependent on the control unit's signals. The general purpose register file 16 is used to store the information and status of the current execution task. The general purpose register file 16 is a group of high-speed registers with a limited capacity, used to temporarily store data, addresses and/or other information about calculation. Moreover, the control and status register 18 and the program counter register 19 are used to store information of the control unit 12.

The logic circuit 20 is provided in the semiconductor apparatus. The logic circuit 20 can synchronously operate more than one CPU 10. Moreover, the logic circuit 20 can use memory direct memory access (‘DMA’). The logic circuit 20 uses direct memory access to move data between the memory 30 and the registers of each CPU 10. The logic circuit 20 can amend the control unit 12 of each CPU 10 so that the logic circuit 20 can temporarily stop the CPU execution through the control unit 12. The logic circuit 20 can amend the access to the general purpose register file 16, the program counter register 19 and the control and status register 18 of the CPU 10 so that the logic circuit 20 can read and write all of the registers of the CPU 10.

In some embodiments, the logic circuit 20 includes a mask swap register 21 so that the logic circuit 20 can determine whether to switch contexts corresponding to tasks based on the context of the mask swap register 21. The mask swap register 21 value is cleared by software. After determining to switch contexts, the logic circuit 20 will temporarily stop the switching of contexts if the logic circuit 20 finds that the mask swap register 21 is set. The logic circuit 20 will resume the switching of contexts immediately after the mask swap register 21 is cleared.

In some embodiments, the logic circuit 20 can further include a timer circuit 25 operable for context-switch cycle time.

The memory 30 can be a dynamic random access memory (‘DRAM’) or a static random access memory (‘SRAM’). The memory 30 is connected to the CPU 10 via a bus 35. A region in the memory 30 is selected to store information about multiple tasks. The information about each task includes the identification (‘ID’), priority, status and context of the task.

As discussed above, a semiconductor apparatus for reducing context-switch time is provided. The semiconductors apparatus can reduce time spent on a multi-task operation and hence improve the efficiency of the multi-task operation.

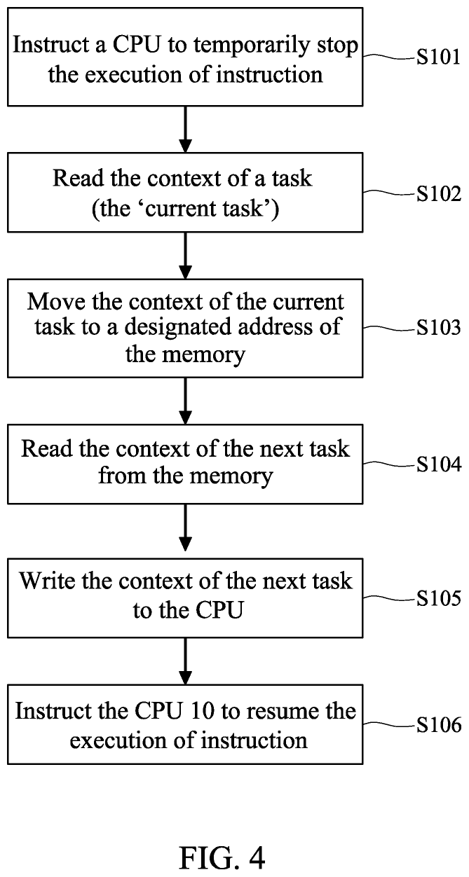

When the semiconductor apparatus is in a multi-task operation, the logic circuit 20 switches the contexts of tasks between the CPU 10 and the memory 30. Referring to FIG. 4, there is shown a context-switching method executed in the semiconductor apparatus.

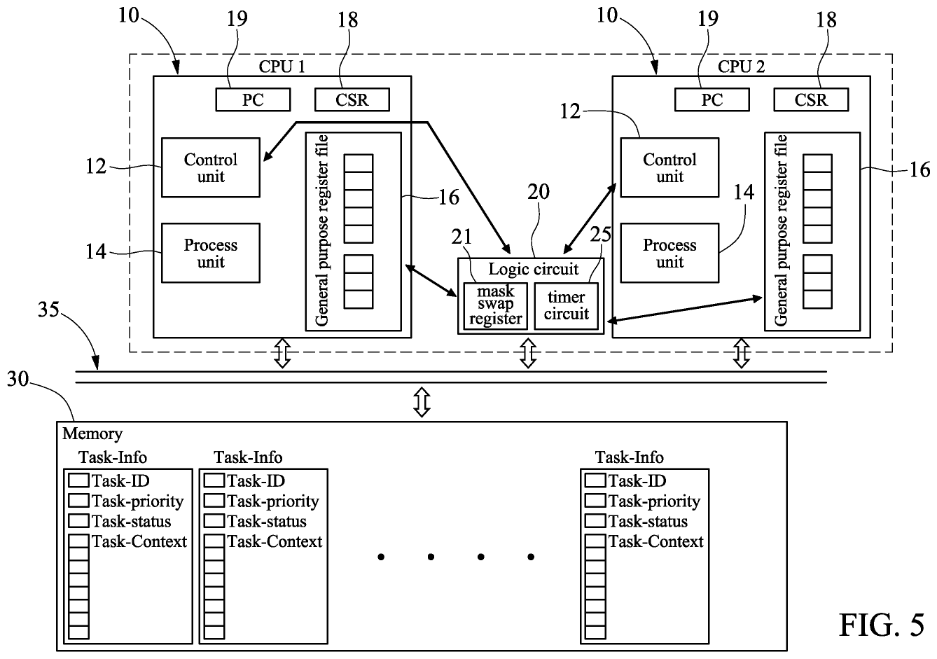

Referring to FIGS. 4 and 5, at S101, the execution of the context-switching method in the semiconductor apparatus will be described in detail. The logic circuit 20 instructs a CPU 10 to temporarily stop the execution of instruction. In specific, the logic circuit 20 instructs the control unit 12 of a CPU 10 to temporarily stop the execution of instruction. Thus, the on-going task also pauses. The logic circuit 20 can synchronously control multiple CPUs 10. However, one task only can be executed in one of the CPUs 10 at any given point of time. The following description will be given to only one CPU 10 for briefness and clarity.

Then, at S102, the logic circuit 20 reads the context of a task (the ‘current task’) executed in the CPU 10. The logic circuit 20 uses the DMA to read the context of a temporarily stopped task (the ‘current task’).

Then, at S103, the logic circuit 20 moves the context of the current task to a designated address of the memory 30. The logic circuit 20 uses the DMA to move the context of the current task to the designated address of the memory 30 from the registers of the CPU 10, and update the current task's ID, priority and status for the next time of execution. As mentioned above, in some embodiments, the logic circuit 20 determines whether to switch contexts according to the context of the mask swap register 21. Moreover, in some embodiments, the logic circuit 20 switches contexts according to timeout value in the timer circuit 25.

Then, at S104, the logic circuit 20 reads the context of the next task from the memory 30. The logic circuit 20 reads the context of the task that is top priority in the memory 30 according to the ID, priority and status.

Then, at S105, the logic circuit 20 writes the context of the next task to the CPU 10. The logic circuit 20 uses the DMA to write the context of the next task to the registers of the CPU 10.

Then, at S106, the logic circuit 20 instructs the CPU 10 to resume the execution of instruction. The logic circuit 20 instructs the control unit 12 of the CPU 10 to resume the execution of instruction after writing the context of the next task to the CPU 10 registers.

As discussed above, the logic circuit 20 uses the DMA to move the context of the current task to the memory 30 from the CPU 10 registers and move the context of the next task to the CPU 10 registers from the memory 30. The steps represented by S101 to S106 are repeated to complete a multi-task operation. The data moving time by DMA of the logic circuit is much smaller than the data moving time by software. Hence, the efficiency of the switching of contexts according to the present invention is higher than that of the prior art.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A semiconductor apparatus for reducing context-switch time comprising:
at least one CPU (10) comprising a control unit (12), a process unit (14) and registers (16, 18, 19); and
a logic circuit (20) that uses direct memory access to read and write the registers of the CPU (10) and move data between the registers of the CPU (10) and at least one memory (30) for storing information of multiple tasks, wherein the information of each of the tasks comprises an identification, priority, status and context, wherein the logic circuit (20) is operable to instruct the control unit (12) to stop and resume execution of a command of the CPU (10).

2. The semiconductor apparatus according to claim 1, comprising multiple CPUs (10), wherein the logic circuit (20) is operable to control the multiple CPUs (10).

3. The semiconductor apparatus according to claim 1, wherein the logic circuit (20) comprises a mask swap register (21) operable to determine whether the contexts of the tasks should be switched, wherein the mask swap register (21) is controlled by software.

4. The semiconductor apparatus according to claim 1, wherein the logic circuit (20) further comprises a timer circuit (25) operable to the task running time before context switches.

5. The semiconductor apparatus according to claim 1, wherein the memory (30) is selected from the group consisting of a dynamic random access memory or a static random access memory.

6. The semiconductor apparatus according to claim 1, wherein the registers comprise at least one general purpose register file (16), at least one control and status register (18) and at least one program counter register (19).

7. A semiconductor apparatus for reducing context-switch time comprising:
at least one CPU (10) comprising a control unit (12), a process unit (14) and registers (16, 18, 19);
at least one memory (30) for storing information of multiple tasks, wherein the information of each of the tasks comprises an identification, priority, status and context; and
a logic circuit (20) that uses direct memory access to read and write the registers of the CPU (10) and move data between the registers of the CPU (10) and the memory (30), wherein the logic circuit (20) is operable to instruct the control unit (12) to stop and resume the execution of instruction in the CPU (10).

8. A method for operating the semiconductor apparatus set forth in claim 1 to reduce context-switch time comprising the steps of:
using the logic circuit (20) to temporarily stop the execution of instruction in the CPU (10) (S101);
using the logic circuit (20) to read the context of a current task executed in the CPU (10) (S102);
using the logic circuit (20) to move the context of the current task to a designated address of the memory (30) from the registers of the CPU (10) and change the priority of the current task (S103);
using the logic circuit (20) to obtain the context of a next task from the memory (30) (S104);
using the logic circuit (20) to write the context of the next task in some of the registers of the central processor unit (10) (S105); and
using the logic circuit (20) to instruct the CPU (10) to resume the execution of instruction (S106).

9. The method according to claim 8, wherein the logic circuit (20) comprises a mask swap register (21) operable to determine whether the contexts of the tasks should be switched.

10. The method according to claim 8, wherein the logic circuit (20) further comprises a timer circuit (25) operable to set the task-running time before context switches.
